(19) United States
(12) Patent Application Publication
(10) Pub. No.: US 2015/0278878 A1
(43) Pub. Date: Oct. 1, 2015

(54) SYSTEM AND METHOD OF DISPLAYING ADVERTISEMENTS

(71) Applicant: Stephen Chau, Stanford, CA (US)

(72) Inventor: Stephen Chau, Stanford, CA (US)

(73) Assignee: GOOGLE INC., Mountain View, CA (US)

(21) Appl. No.: 12/557,017

(22) Filed: Sep. 10, 2009

(51) Int. Cl. G06Q 30/02; G09G 5/00; G06Q 50/00

(52) U.S. Cl. CPC G06Q 30/0276

(57) ABSTRACT

In one aspect, a system and method is provided whereby advertisements are associated with a first image, and if a second image is displayed that is visually similar to the first image, the advertisement is displayed in connection with the second image as well.

### BACKGROUND OF THE INVENTION

Services such as Google Maps provide users with the ability to view maps. They also provide businesses and other users with the ability to upload information that may be used to advertise in connection with the map. For example, when users search maps for local information, they may see information about businesses located in the area, such as the business' address, hours of operation, photos or products, and other information that the business may choose to advertise. This information may be shown as a pop-up window that appears on the map when an icon associated with business is clicked.

Google Maps is also capable of displaying street level images of geographic locations. These images, identified in Google Maps as “Street Views”, typically comprise photographs of buildings and other features and allow a user to view a geographic location from a person's perspective as compared to a top-down map perspective. The street level images tend to be taken at discrete locations.

Services such as Google AdSense provide advertising to a website by using factors such as keyword analysis, word frequency, font size, and the overall link structure of the web, in order to determine what a webpage is about and select ads to be displayed on the page.

### BRIEF SUMMARY OF THE INVENTION

In one aspect, a method of displaying content is provided. The method includes receiving first content associated with a first street level image, where the first street level image represents a geographic object that is associated with a first geographic location. The method further includes receiving second information to be displayed, the second information being associated with a second image where the second image is associated with a second geographic location. The method also selects, with a processor, the first street level image based on the proximity of the first location to the second location and determines, with a processor, whether the first street level image is visually similar to the second image. The first content is provided in response to receiving the second information when the first street level image is determined to be visually similar to the second image. The first content is provided for display on an electronic display along with the second information.

Yet another aspect provides a method of displaying an advertisement. The method includes: receiving, via a network from a first node, an advertisement to be displayed with a first image, the first image being captured at a camera location; receiving, via the network from a second node, a request for an advertisement, the request identifying a second image captured by a camera and identifying a second location; selecting, with a processor, the first image from among a plurality of images based on a comparison of the camera location with the second location and a comparison of the visual appearance of the first image with the second image; selecting the advertisement based on the selection of the first image; and transmitting the advertisement via the network for display with the second image.

Still another aspect is a system that includes a first and second client device and a first and second server. The first client device is at a first node of a network and has a first memory storing a first set of instructions, a first processor that processes data in accordance with the first set of instructions, as well as an electronic display. It is operated by a first user. The second client device is at a second node of the network and has a second memory storing a second set of instructions, and a second processor that processes data in accordance with the second set of instructions. It is operated by a second user. The first server and second server are at a third and fourth node of the network and include a third and fourth set of instructions and a third and fourth processor, respectively. The third set of instructions include: receiving first information from the first user where the first information is associated with a street level image accessed by the second client device, receiving second information and a second image from the second server, selecting the first information if the location of the street level image is proximate to a location associated with the second image and the street level image is visually similar to the second image, and providing the selected first information to the second server. The fourth set of instructions include: receiving a request for information from the second user, providing the second information and the second image to the second server in response to the request for information from the second user, receiving the first information, providing the first information and second information to the second client device.

Yet another method provides transmitting, over a network from a first node, a request for a web page, receiving the web page from the network and displaying the image on an electronic display. The web page includes a first image of geographic objects and an advertisement. The advertisement was selected based on a comparison, by a processor, of a second image with the first image where the second image is associated with the advertisement and the advertisement was received from a different node of the network than the first node.

Still another aspect provides a system that includes a user input device, a memory storing instructions, a processor in communication with the user input device so as to process information received from the user input device in accordance with the instructions, and a display in communication with, and displaying data received from, the processor. The instructions include transmitting, over a network from a first node, a request for a web page, receiving, from the network, the web page (where the web page includes a first image of geographic objects and an advertisement, and the advertisement was selected based on a comparison, by a processor, of a second image with the first image where the second image is associated with the advertisement and the advertisement was received from a different node of the network than the first node) and providing the image to the electronic display.

### BRIEF DESCRIPTION OF THE DRAWINGS

FIG. 1 is a functional diagram of a system in accordance with an aspect of the invention.

FIG. 2 is a pictorial diagram of a system in accordance with an aspect of the invention.

FIG. 3 is a street level image, captured by a camera, in accordance with an aspect of the invention.

FIG. 4 is a diagram functionally illustrating, in accordance with an aspect of the invention, the relative geographic positions of objects within a street level image and the position and angle of a camera used to capture the street level image.

FIG. 5 is a screen shot in accordance with an aspect of the invention.

FIG. 6 is a screen shot in accordance with an aspect of the invention.

FIG. 7 is a screen shot in accordance with an aspect of the invention.

FIG. 8 is a screen shot in accordance with an aspect of the invention.

FIG. 9 is a screen shot in accordance with an aspect of the invention.

FIG. 10 is a screen shot in accordance with an aspect of the invention.

FIG. 11 is a screen shot in accordance with an aspect of the invention.

FIG. 12 displays information to be displayed on a webpage.

FIG. 13 illustrates a comparison of an image from a webpage with two street level images.

FIG. 14 illustrates a comparison of a portion of an image from a webpage with a portion of a street level image.

FIG. 15 illustrates a comparison of a portion of an image from a webpage with a portion of a street level image.

FIG. 16 is a screen shot in accordance with an aspect of the invention.

FIG. 17 is a screen shot in accordance with an aspect of the invention.

FIG. 18 is a screen shot in accordance with an aspect of the invention.

FIG. 19 is a flowchart in accordance with an aspect of the invention.

FIG. 20 is a flowchart in accordance with an aspect of the invention.

### DETAILED DESCRIPTION

In one aspect, a system and method is provided whereby advertisements are uploaded to a server by a user in connection with a street level image. Before displaying a webpage to a user, another website may request an advertisement from the server. The server selects an advertisement by selecting a street level image that is associated with an advertisement, is visually similar to an image stored on the webpage, and is proximate to a location associated with the webpage. The advertisement is provided to the website, which inserts it into the webpage.

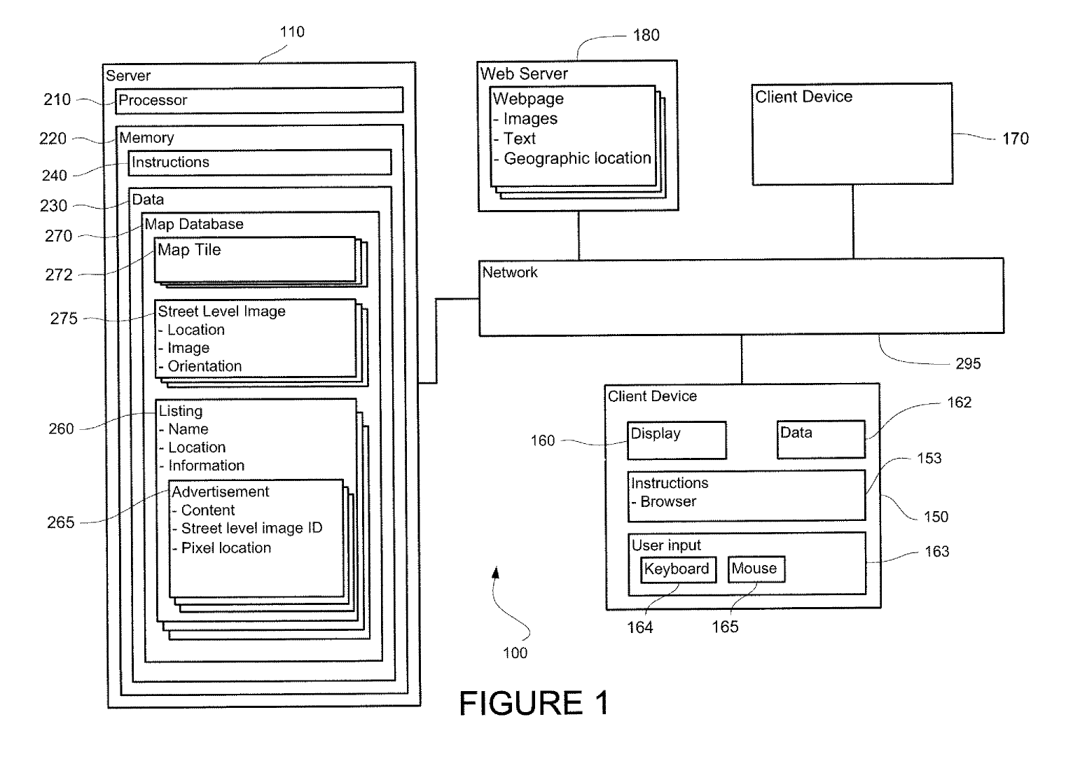

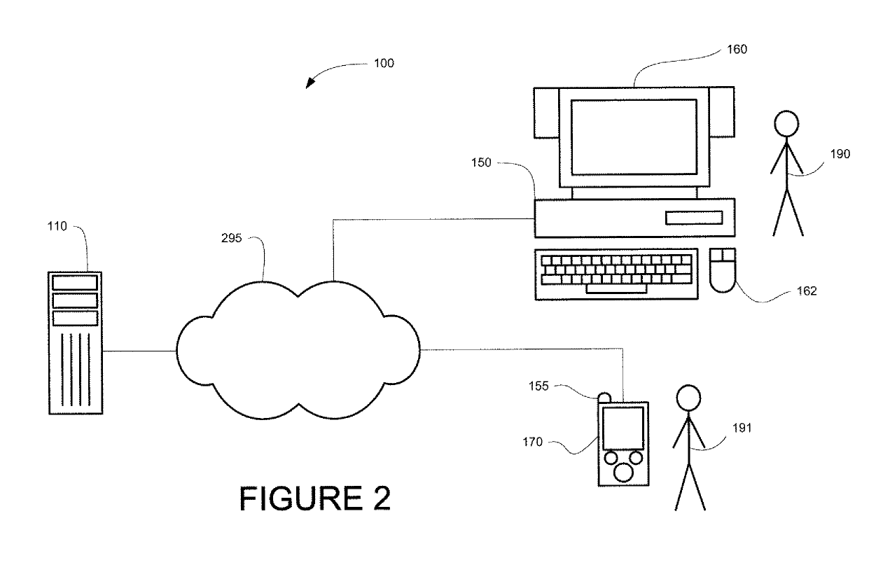

As shown in FIGS. 1-2, a system 100 in accordance with one aspect of the invention includes a computer 110 containing a processor 210, memory 220 and other components typically present in general purpose computers.

Memory 220 stores information accessible by processor 210, including instructions 240 that may be executed by the processor 210. It also includes data 230 that may be retrieved, manipulated or stored by the processor. The memory may be of any type capable of storing information accessible by the processor, such as a hard-drive, memory card, ROM, RAM, DVD, CD-ROM, write-capable, and read-only memories. The processor 210 may be any well-known processor, such as processors from Intel Corporation or AMD. Alternatively, the processor may be a dedicated controller such as an ASIC.

The instructions 240 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 230 may be retrieved, stored or modified by processor 210 in accordance with the instructions 240. For instance, although the system and method is not limited by any particular data structure, the data may be stored in computer registers, in a relational database as a table having a plurality of different fields and records, XML documents, or flat files. The data may also be formatted in any computer-readable format such as, but not limited to, binary values, ASCII or Unicode. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one aspect, computer 110 is a server communicating with one or more client devices 150, 170. For example, computer 110 may be a web server. Each client device may be configured similarly to the server 110, with a processor, memory and instructions. Each client device 150, 170 may be a personal computer, intended for use by a person 190-191, having all the internal components normally found in a personal computer such as a central processing unit (CPU), display device 160 (for example, a monitor having a screen, a projector, a touch-screen, a small LCD screen, a television, or another device such as an electrical device that is operable to display information processed by the processor), CD-ROM, hard-drive, user input (for example, a mouse 163, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers including general purpose computers, PDAs, network computers lacking local storage capability, and set-top boxes for televisions.

Although the client devices 150 and 170 may comprise a full-sized personal computer, the system and method may also be used in connection with mobile devices capable of wirelessly exchanging data with a server over a network such as the Internet. For example, client device 170 may be a wireless-enabled PDA such as a Blackberry phone or an Internet-capable cellular phone. In either regard, the user may input information using a small keyboard (in the case of a Blackberry phone), a keypad (in the case of a typical cell phone), a touch screen (in the case of a PDA) or any other means of user input.

The server 110 and client devices 150 and 170 are capable of direct and indirect communication, such as over a network 295. Although only a few computers are depicted in FIGS. 1-2, it should be appreciated that a typical system can include a large number of connected computers, with each different computer being at a different node of the network 295. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces.

Although certain advantages are obtained when information is transmitted or received as noted above, other aspects of the system and method are not limited to any particular manner of transmission of information. For example, in some aspects, information may be sent via a medium such as a disk, tape or CD-ROM. In other aspects, the information may be transmitted in a non-electronic format and manually entered into the system. Yet further, although some functions are indicated as taking place on a server and others on a client, various aspects of the system and method may be implemented by a single computer having a single processor.

Other nodes of the network may include servers hosting websites, such as web server that hosts web pages containing images and text. The text may or other information associated with the website may be associated with a geographic location. For example, as explained in more detail below, web server 180 may host a website devoted to photography of buildings.

Map database 270 of server 110 stores map-related information, at least a portion of which may be transmitted to a client device. For example, map database 270 may store map tiles 272, where each tile is a map image of a particular geographic area. Depending on the resolution (e.g., whether the map is zoomed in or out), one tile may cover an entire region such as a state in relatively little detail. Another tile may cover just a few streets in high detail. The map information is not limited to any particular format. For example, the images may comprise street maps, satellite images, or a combination of these, and may be stored as vectors (particularly with respect to street maps) or bitmaps (particularly with respect to satellite images). The various map tiles are each associated with geographical locations, such that the server 110 is capable of selecting, retrieving and transmitting one or more tiles in response to receipt of a geographical location.

As further described below, locations may be expressed and requested in various ways including but not limited to latitude/longitude positions, street addresses, points on a map (such as when a user clicks on a map), building names, other data capable of identifying one or more geographic locations, and ranges of the foregoing.

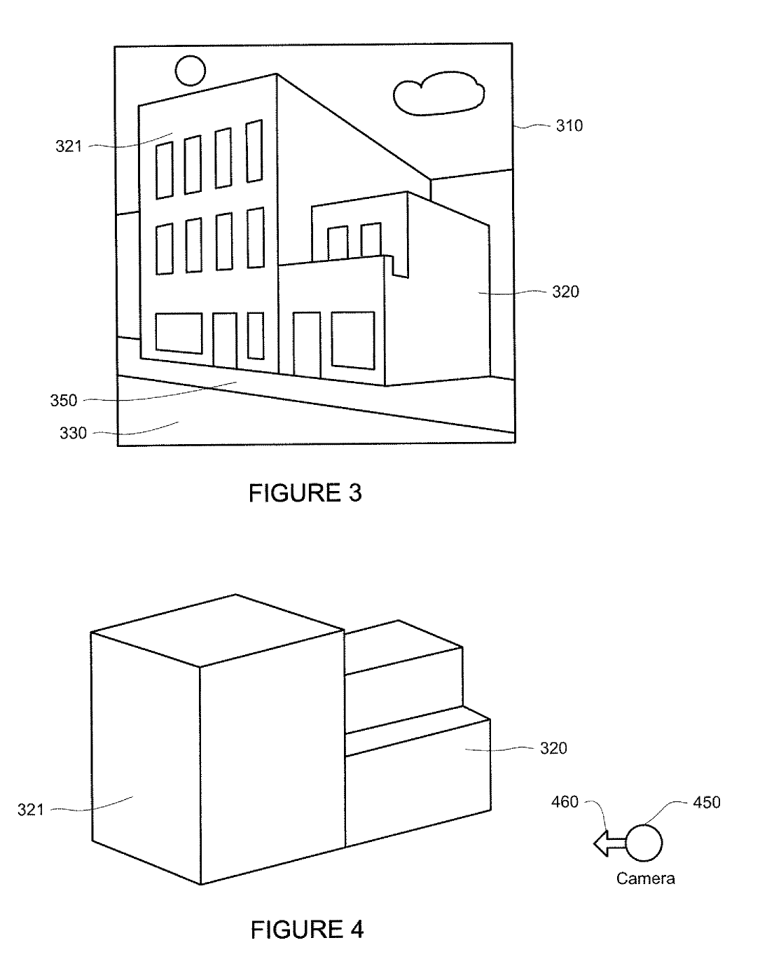

The map database may also store street level images 275. A street level image is an image of geographic objects that was captured by a camera at an angle generally parallel to the ground. Both the geographic objects in the image and the camera have a geographic location relative to one another. Thus, as shown in FIG. 3, street level image data may represent various geographic objects such as buildings 320-321, sidewalks 350 and street 330. It will be understood that while street level image 310 only shows a few objects for ease of explanation, a typical street level image will contain as many objects associated with geographic locations (street lights, mountains, trees, bodies of water, vehicles, people, etc.) in as much detail as the camera was able to capture. FIG. 4 pictorially illustrates the geographic locations of the buildings 320-21 relative to the geographic position 450 and angle 450 of the camera when the image was captured.

The objects in the street level images may be captured in a variety of different ways. For example, the street level image may be captured by a camera mounted on top of a vehicle, from a camera angle pointing roughly parallel to the ground and from a camera position at or below the legal limit for vehicle heights (e.g., 7-14 feet). (Street level images are not limited to any particular height above the ground; a street level image may be taken from the top of building.) Panoramic street-level images may be created by stitching together a plurality of photographs taken from different camera angles. The camera may be any device capable of capturing optical images of objects including film cameras, digital still cameras, analog video cameras and image sensors (by way of example, CCD, CMOS or other).

Each street level image may be stored as a set of pixels associated with color and brightness values. For example, if the images are stored in JPEG format, the image will be displayed as a set of pixels in rows and columns, with each pixel being associated with a value that defines the color and brightness of the image at the pixel's location.

In addition to being associated with geographic locations, street level images 275 are typically associated with information indicating the orientation of the image. For example, if the street level image comprises a typical photograph, the orientation may simply be the camera angle such as an angle that is 30° east of true north and rises 2° from ground level. If the street level images are panoramic images, such as 360° panoramas centered at the geographic location associated with the image, the orientation may indicate the portion of the image that corresponds with looking due north from the camera position at an angle directly parallel to the ground.

Street level images may also be stored in the form of videos, such as by displaying MPEG videos captured by an analog video camera or displaying, in succession, time-sequenced photographs that were captured by a digital still camera.

Map database 270 may also store listing information 260 identifying local businesses or other objects or features associated with particular geographic locations. For example, each listing 274 may be associated with a name, a category (such as “pizza”, “Italian restaurant” or “ballpark”), other information and a location. The database may be compiled by automatically gathering business information (such as from websites or telephone directories), or users may enter or edit the listing information themselves via web pages served by the server 110.

As explained in more detail below, listings 274 may further be associated with advertisements 265. Each advertisement, in turn, may be associated with data identifying content, the identity of a street level image and a location on a surface of an object represented in the street level image.

In many cases, there will be a single listing 274 in the map database 270 for each different business. However, it will be understood that the same business may be associated with many different listings, and that a single listing may be associated with many different businesses.

Listings may include other geographically-located objects in addition to or instead of businesses. For example, they may also identify homes, landmarks, roads, bodies of land, the current position of a car, items located in a store, etc. Therefore, references to business listings will be understood as examples only, and not a limitation on the type of listings, or advertisements associated therewith, that may be the subject of the system and method.

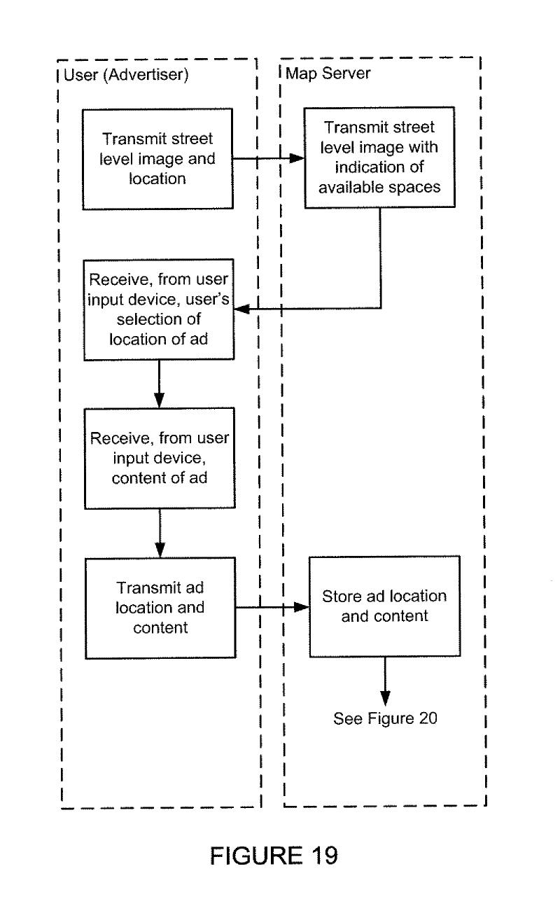

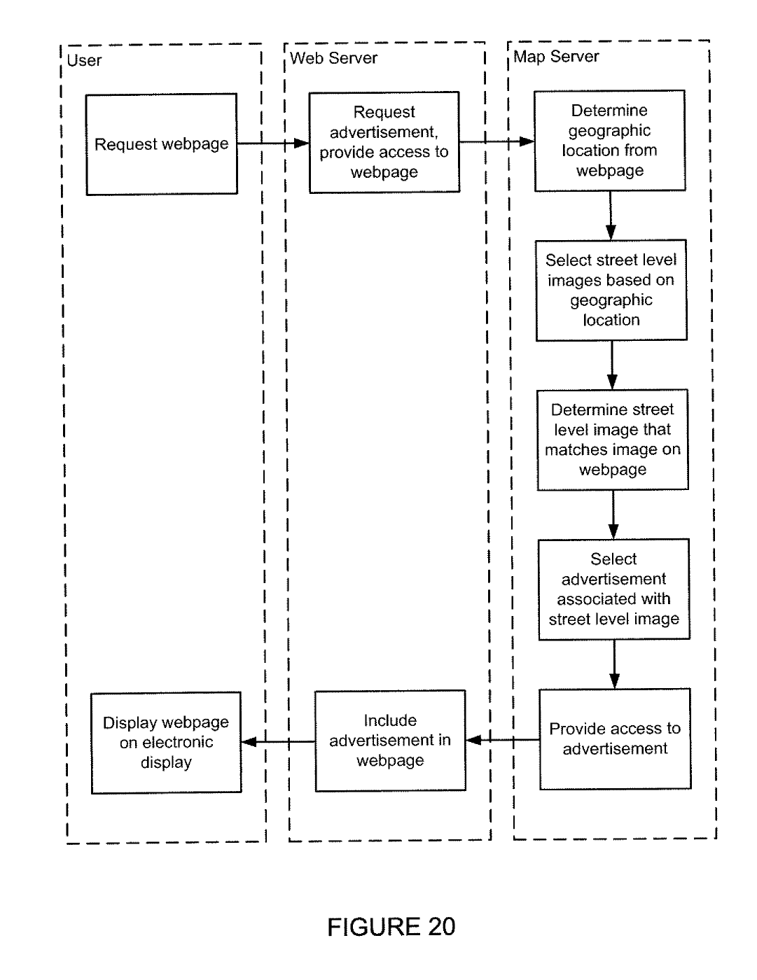

In addition to the operations illustrated in FIGS. 19-20, various operations in accordance with a variety of aspects of the invention will now be described. It should be understood that the following operations do not have to be performed in the precise order described below. Rather, various steps can be handled in reverse order or simultaneously.

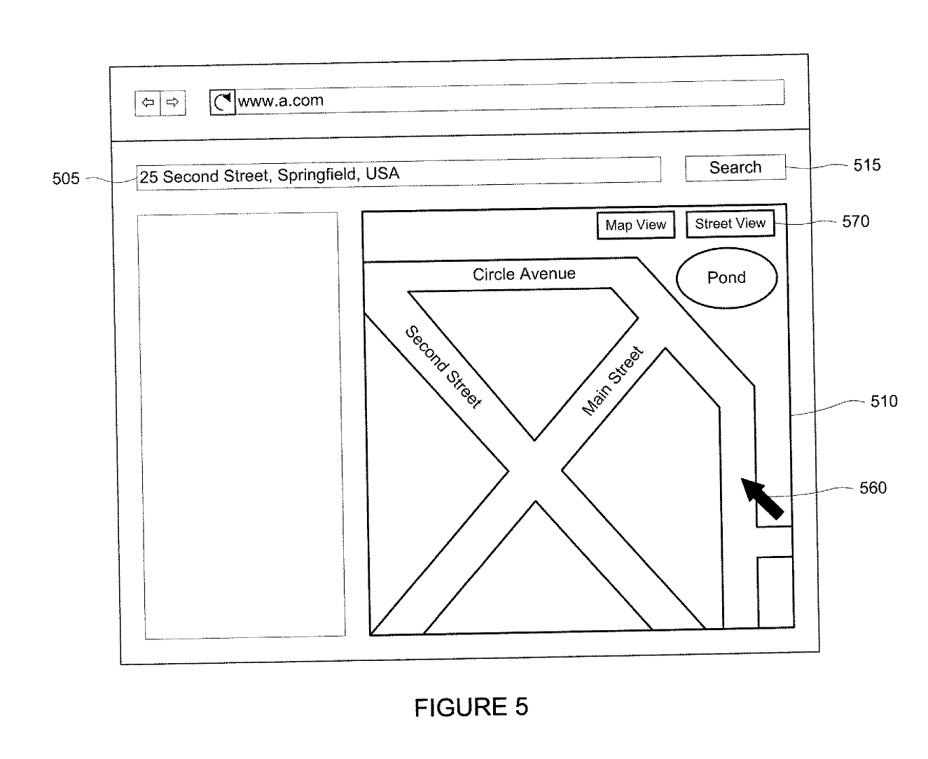

FIG. 5 illustrates a screen shot that may be displayed by the display associated with a client device such as client device 150. For example, the system and method may be implemented in connection with an Internet browser such as Google Chrome displaying a web page showing a map 510 and other information. The program may provide the user with a great deal of flexibility when it comes to requesting a location to be shown in a street level view. For example, the user may enter text identifying a location in textbox 505 such as an address, the name of a building, or a latitude and longitude. The user may then transmit the location to the server by selecting search button 515. The user may further use a mouse or keypad to move a mouse cursor 560 to identify a particular geographical location on the map. Yet further, the program may provide a button 570 or some other feature that allows a user to request a street level view at the specified geographical location.

The street level image is retrieved based on the location requested by the user. For example, the user may have used a keyboard to enter a street address into a browser. When the street address is transmitted by the client device 150 to the server 110, the server may use a geocoder to convert the street address into a latitude/longitude. The server then may then select the street level image that is associated with the latitude/longitude value that is closest to the converted latitude/longitude value. Yet further, the user may have clicked a particular location on the map 510 to view from a street level perspective.

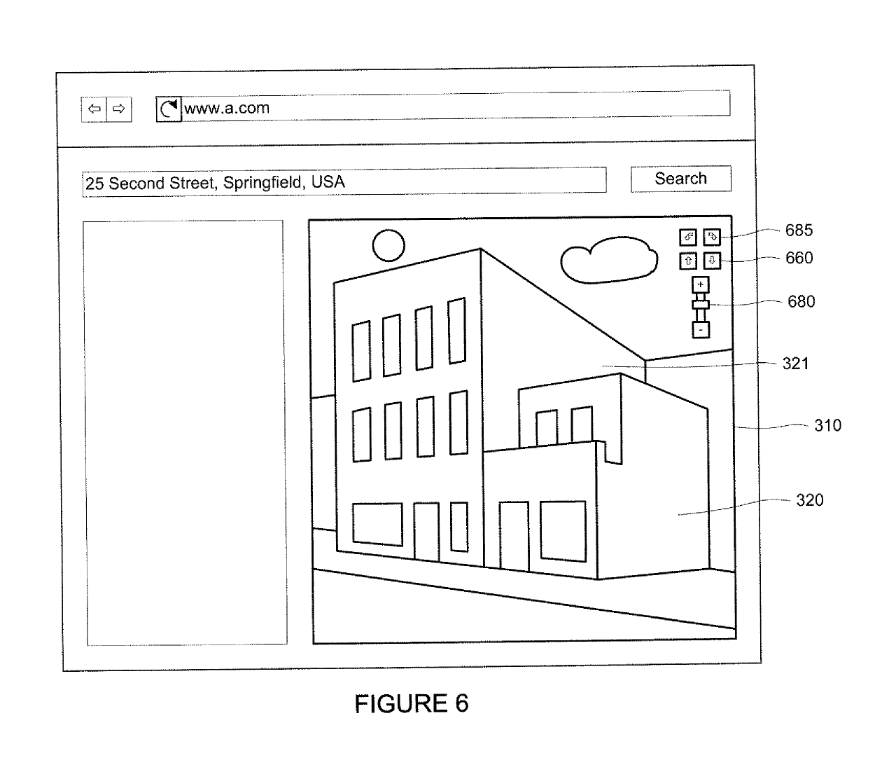

As shown in FIG. 6, the street level image 310 of geographic objects 320-21 may be shown in the browser along with user-selectable controls for changing the location or orientation of the viewpoint. The controls may include controls 680 for zooming the image in and out, as well as controls 685 to change the orientation of the view, such as changing the direction from looking northeast to looking northwest. If the street level image was downloaded as an entire 360° panorama, changing the direction of the view may necessitate only displaying a different portion of the panorama without retrieving more information from the server.

The user may also change the location of the viewpoint. For example, the user may move the viewpoint forwards or backwards in the currently-viewed direction by selecting controls 660.

Other navigation controls may be included as well, such as controls in the form of arrows disposed along a street that may be selected to move the vantage point up or down the street. A user may also operate the arrow controls of a keyboard to change the zoom, direction or location of the view. A user may further select portions of the image, such as by moving and clicking a computer mouse or tapping a touch-sensitive screen, to select and move closer to the objects displayed in the image. Depending on the street level image data that was downloaded, a change in location may necessitate the client device obtaining more street level image data from the server. Thus, changing locations may cause the client device to retrieve a different street level image.

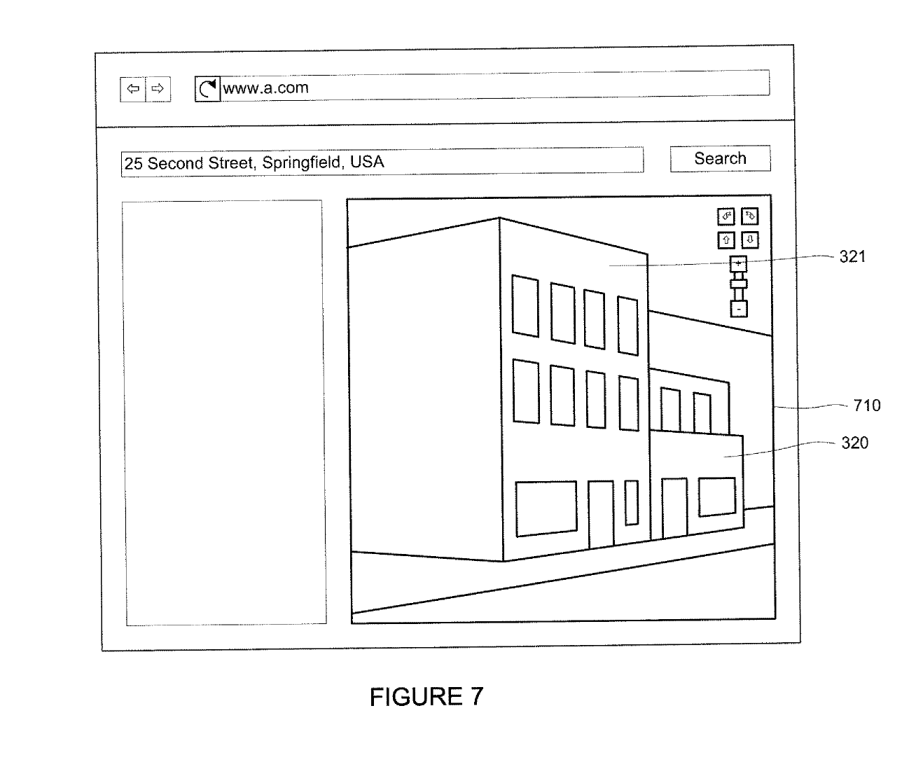

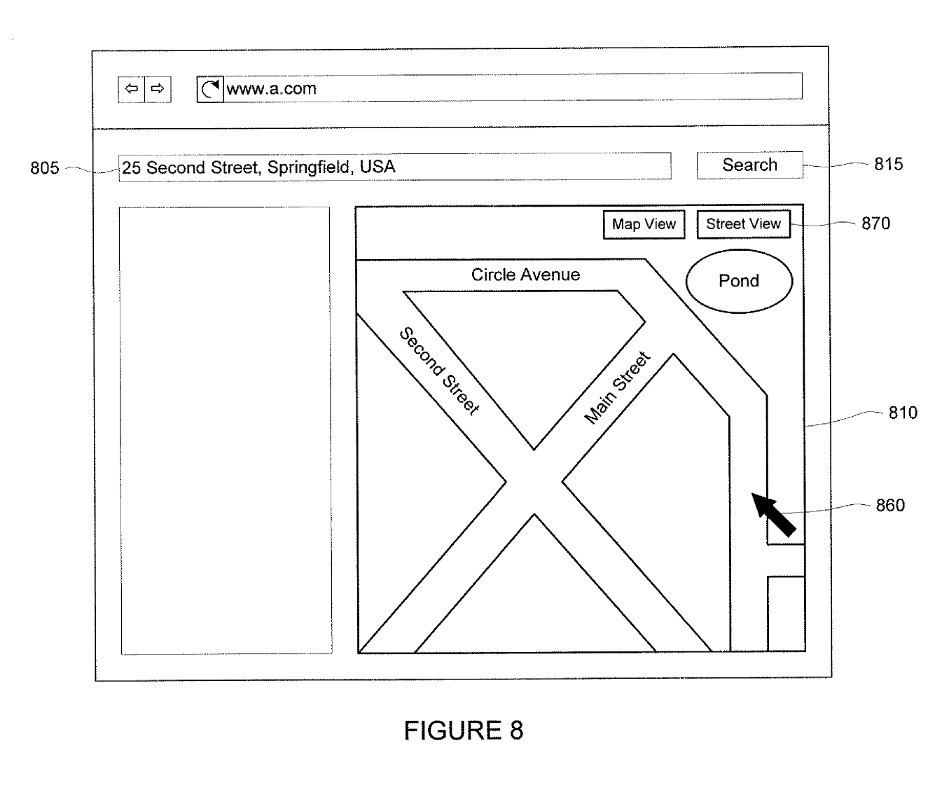

FIG. 7 illustrates how the geographic objects 320-21 of FIG. 6 may appear when viewed from another location and camera angle. Specifically, street level image 710 is a different image inasmuch as it was taken at a different camera location and angle. Even so, it captures two of the same buildings as street level image 710 even though it does so from a different perspective. Similarly, FIG. 8 shows street level image 810 that captured the same two geographic objects 320-21 from yet another camera position and angle; specifically, directly in front of and facing the two buildings.

In one aspect, a user may associate information, such as advertisements, with the street level image such that the information appears in connection with other images as well.

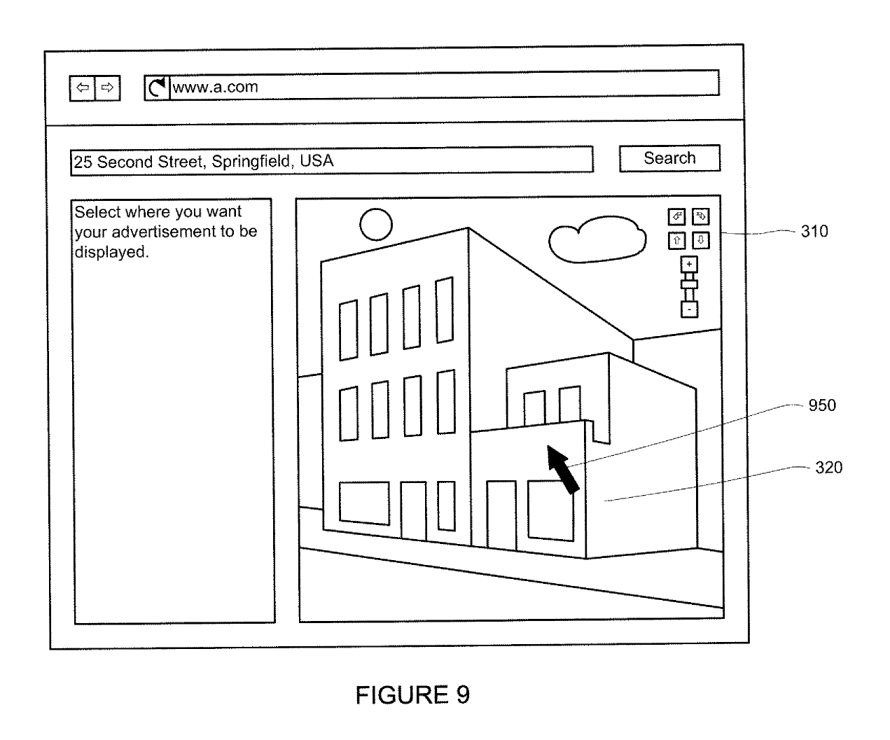

The user may be presented with various options when it comes to associating advertising with an image. As shown in FIG. 9, the user may use mouse cursor 950 to identify the spot at which the advertisement will appear.

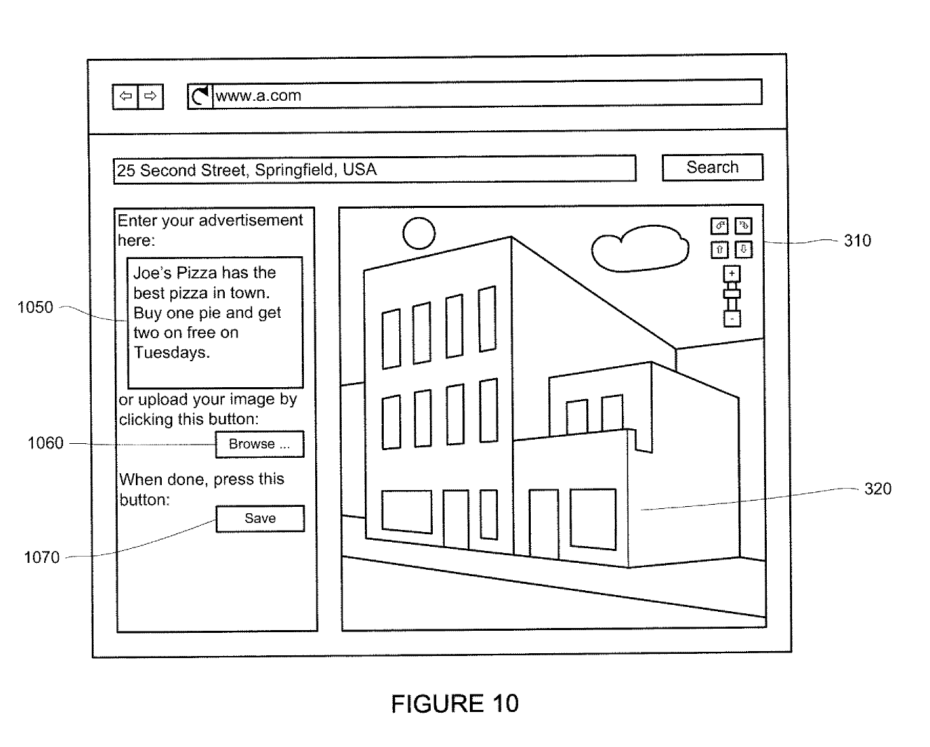

The user may also provide the content of their advertisement. For example and as shown in FIG. 10, the user may be provided with a textbox 1050 for entering text-based advertising. The user may also be provided with the option 1060 of using an image instead, such as by identifying and transmitting an image file from the client device 150 to the server 110. The advertisement may further be associated with a listing, such that the listings information (e.g., name, address, phone, etc.) is also associated with the advertisement.

The server may store the advertisement's content, listing, street level image and location on the street level image in memory for later retrieval.

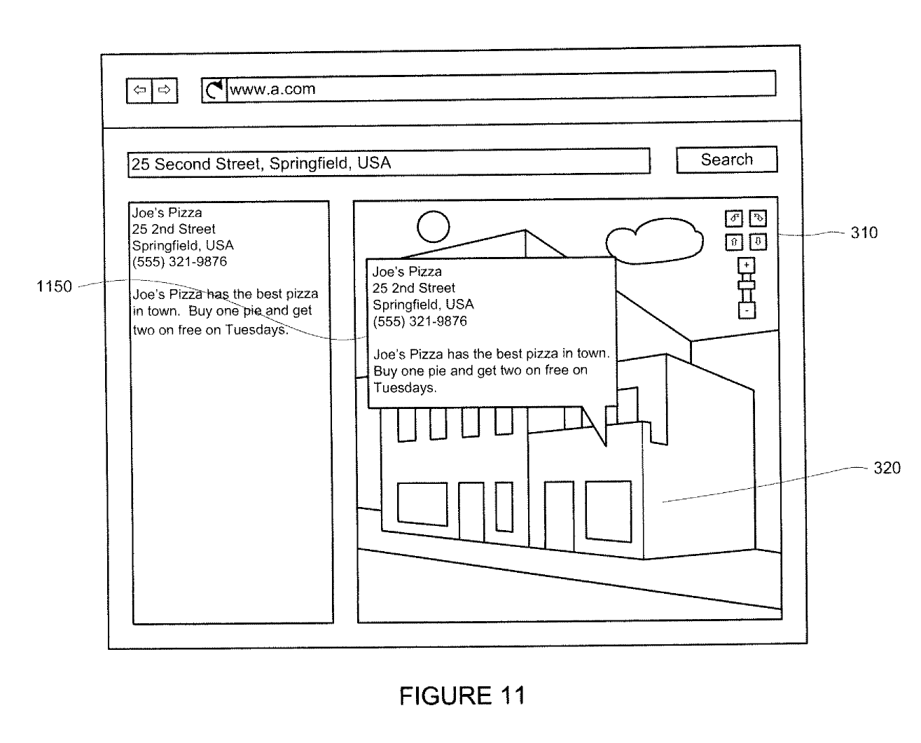

When a user downloads the street level image associated with the advertisement, the client device may display it. By way of example only, a node of the network different from the node that uploaded the advertisement may navigate to a street level image that shows the advertisement. Specifically, a user of client device 170 (FIG. 1) may request a street level image 275 at a particular location. When the system and method provides a street level image to be displayed by the requesting user, it may determine whether an advertisement is associated with the street level image. For example, when client device 170 requests a street level image 275 associated with a particular location, server 110 may determine whether the portion of the street level image to be displayed is also showing a pixel location that is associated with an advertisement 265. If so, the server provides the advertisement 1150 to the client device as shown in FIG. 11.

The advertisement may be provided to the client device in various ways, including the server generating a copy of the street level image, determining the pixels that will display the advertisement instead of the captured images, replacing the pixel's image information with the image information of the advertisement, and transmitting the modified street level image to the client device. The client device may similarly perform the modification. Yet further, the client device may receive both the advertisement and the unaltered street level image, and display the advertisement in a layer above the street level image so that it blocks a portion of the street level image when viewed by the user. Yet further, the advertisement may be shown adjacent to the image, such as in box 1560.

The same advertisement, or other information associated with the street level image, may be shown in connection with other websites having visually similar images.

When a user downloads information from a node of the network that participates in the system and method, the information may be analyzed by a processor in order to select advertising that corresponds with the information. For example, in response to a request from client device 170 for a webpage stored at web server 180 (FIG. 1), web server 180 may request advertising information from server 110 and provide server 110 with access to the information contained in the requested webpage 182.

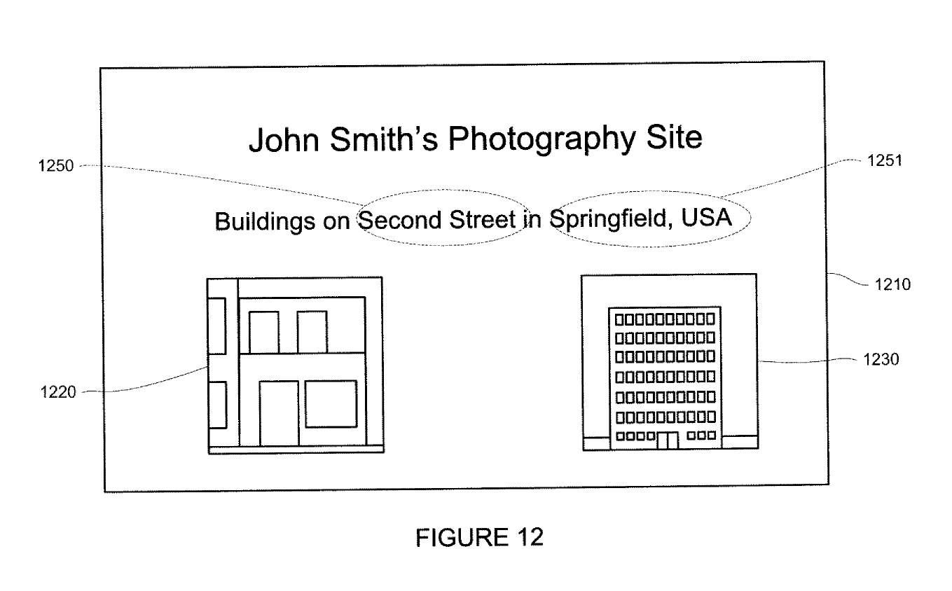

In one aspect, the advertisement is shown on participating websites. For example, FIG. 12 illustrates the HTML document 1210 of a fictional photography site. The site includes photographs 1220 and 1230. It may also include information indicative of a geographic location such as text mentioning a street name 1250 and city name 1251.

In order to select the advertisement, the processor may determine whether any of the images retrieved in response to the user request match any images that are already associated with advertising.

In one aspect, the requested information is analyzed to determine whether it contains any images associated with a geographic location. In that regard, server 110 may analyze HTML document 1210 (FIG. 12) and determine that it corresponds with a geographic location because of the presence of text that is formatted like a street name (“Second Street”) and text that is formatted like a city name (“Springfield, USA”). Accordingly, server 110 may determine that the images 1220, 1230 are associated with a geographic location along Second Street in Springfield, USA.

Other websites may associate the location information with the images in other ways. For example, www.panoramio.com allows users to upload images and associate the images with specific latitude/longitude positions by selecting locations on a map. These images may then be displayed on webpages provided to other users.

The geographic location may then be used to select other images for comparison. For example, server 110 may convert the street address into a latitude/longitude position and the query the map database for all street level images 275 that are proximate to the location. The server may then, or firstly, filter the street level images such that it only selects street level images that are associated with advertisements 265.

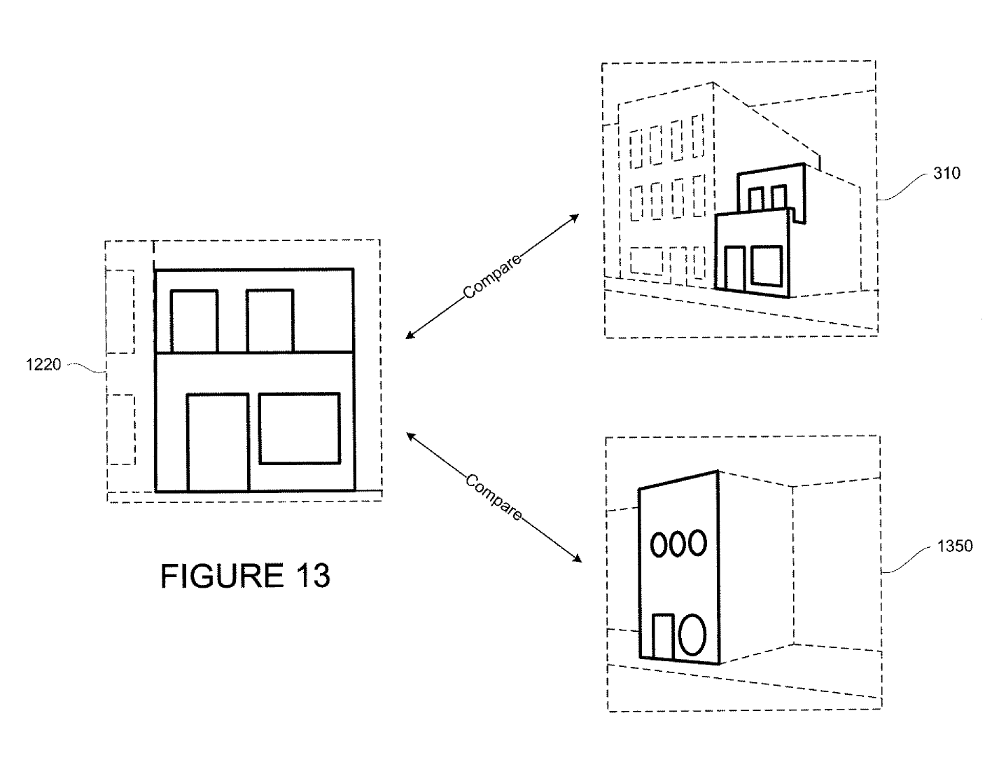

The selected images and the image to be sent to the user are then compared and assigned a value that is based on the amount of visual similarity. FIGS. 13-15 illustrate just one possible system and method for checking for a match.

To test for matches, prominent features of the images may be identified. By way of example only, such features may include geometric shapes such as rectangles, circles and polygons. On a building, these shapes may indicate the outline of a building and the position of windows and doors. FIG. 13 shows, with thick black lines, just some of the prominent features that may be identified in the image 1220 (which was pulled from the photography website) and two different street level images 310 and 1350 that are both associated with Second Street, Springfield, USA.

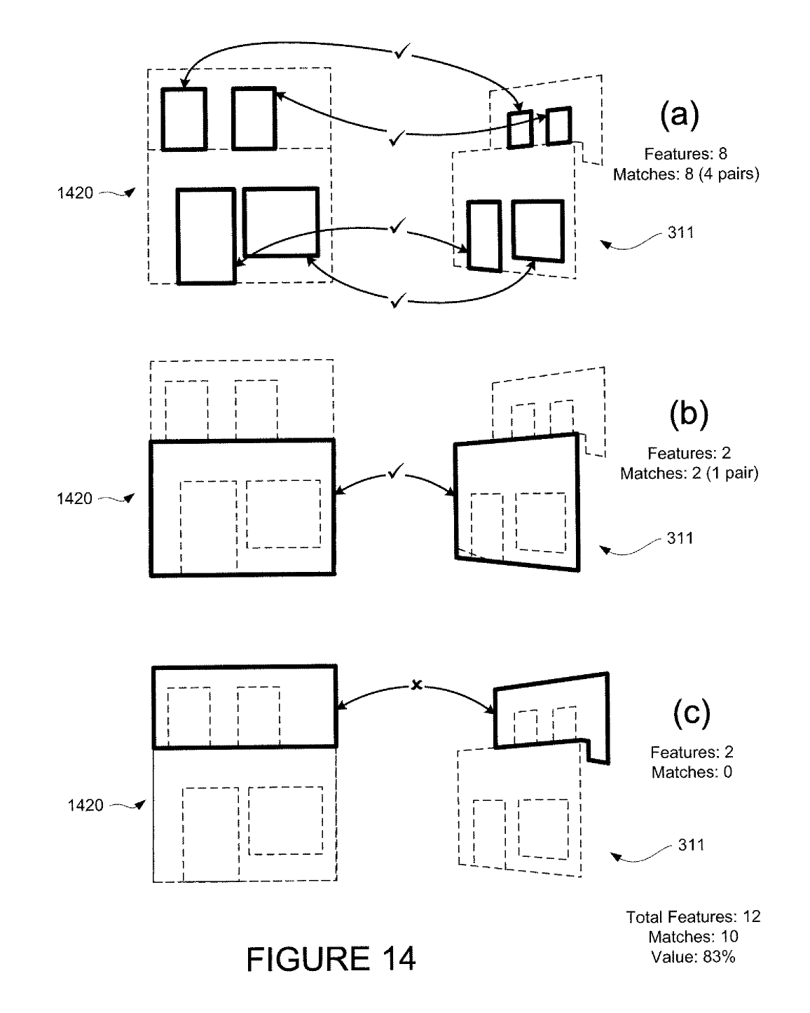

The various features from the images are compared, such as by looking for features that match the shape and position with other similar features. FIG. 14 shows how portions 314 and 1420 of images 310 and 1220, respectively, may be compared with one another. As shown in FIG. 14(a), eight features were identified in the image 1220 and street level image 310 and four of them sufficiently correspond in shape and position to be considered a match (indicated by the checkmark). Similarly, as shown in FIG. 14(b), two features are also found to match. The two features are not an identical match in terms of shape because one is generally rectangular while the one is generally trapezoidal. However, different camera angles of the same object may result in the same feature—in this case the bottom floor of a building—to form different shapes. Accordingly, one aspect of the system and method is preferably able to account for changes in size, rotation and skew.

Not all features will necessarily match. The feature shown in FIG. 14(c) corresponds with the portion of the second floor that faces the street. This particular feature comparison is deemed not to match because the shapes are simply too dissimilar in spite of the fact that they both correspond with the second floor of the same building.

The system and method ascribes a value that indicates the likelihood of the two images identifying the same geometric object. As shown in FIG. 14, the value may relate to the number of matching features compared to non-matching features, such as the number of matching features divided by the total number of features (83% in the case of FIG. 14). This value may be compared against a threshold, whereby exceeding the threshold indicates that the images match. Thus, if the threshold was 75%, the image portions 821 and 311 would be considered a match.

In that regard, street level image 310 may be considered a match to the image 1220 that was obtained from the photography website.

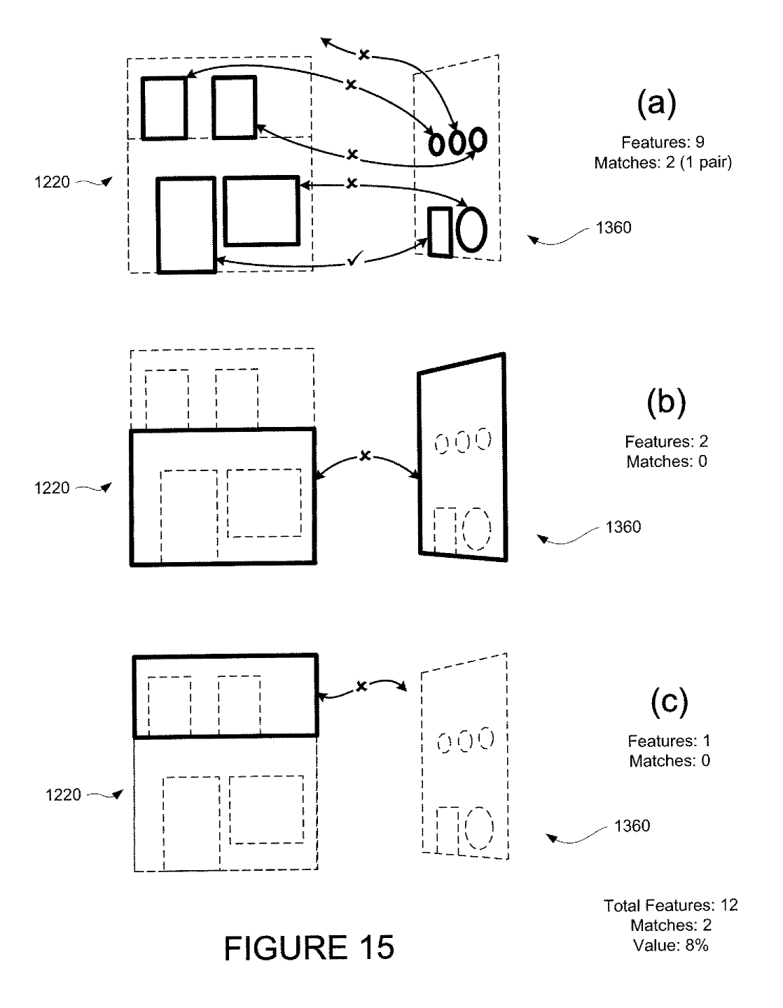

FIG. 15 functionally illustrates a comparison of portions of the image from the photography website with another street level image. As shown in FIG. 15(a), most of the rectangular features in photography image portion 120 have no match in a portion 1360 of street level image 1350 because the windows are shaped differently. Similarly, as shown in FIG. 15(b), while rectangular, the feature associated with the surface facing the street is also considered to be too dissimilar because one is short and wide and the other is tall and skinny. Yet further, there is simply no feature in image portion 1220 that corresponds with the feature associated with the top floor of the building shown in image portion 1360. Accordingly, image portion 1220 is determined not to match image portion 1360.

Various systems and method may be used to compare the images. By way of example only, sets of scale-invariant feature transform (SIFT) features may be computed on a pair of images and used to generate a value indicative of the images similarity. The system and method may analyze the number of matching features that are geometrically consistent somewhere in both images using any number of different geometric models, such as affine, homography or projective geometry transformations. Yet further, features may be identified by looking for edges, where edges are further identified by quick changes in color.

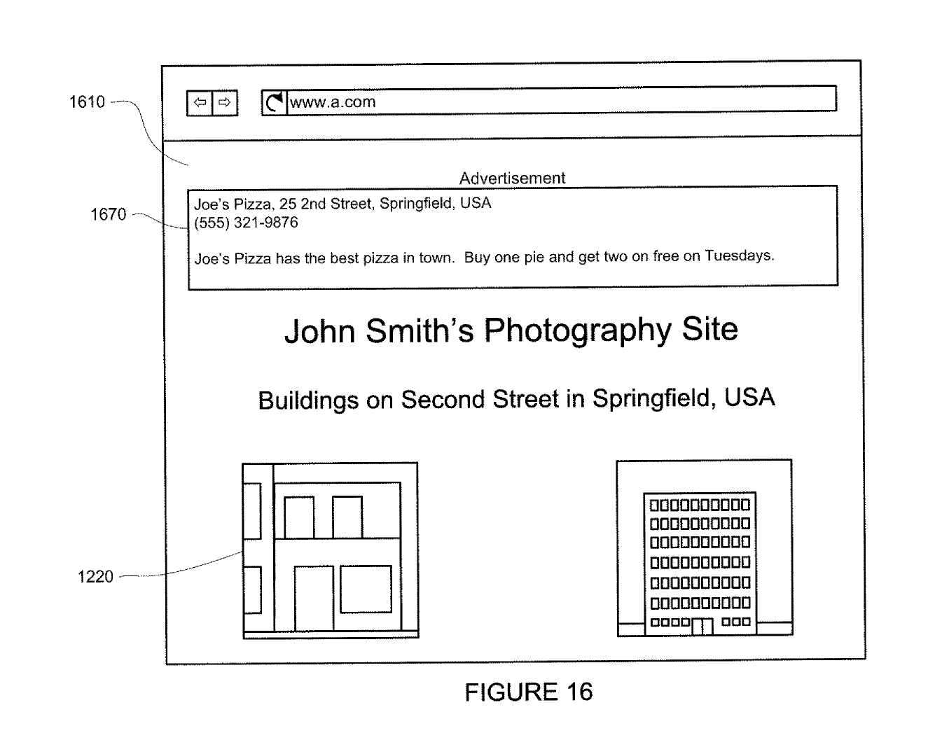

If two images are considered sufficiently visually similar, the advertisement associated with the first image may be used in connection with the second image. For example, as shown in FIG. 16, the content of advertisement 1650 was associated with street level image 310. Street level image 310, in turn, is visually similar to the image 1220 displayed on the photography webpage 1610. Accordingly, in response to the request from web server 180 for advertising, server 110 provides the content of the advertisement 1650 to the web server 180 for insertion into the webpage.

When the information is shown to the user that requested it, the advertisement may be shown along with it. As shown in FIG. 16, the photography website may include the advertisement 1670 in the webpage 1610 along with the other information in the webpage. The advertisement may include not only the content provided by the user, but information contained in the advertisement's associated listing as well. The advertisement is thus syndicated to the photography site.

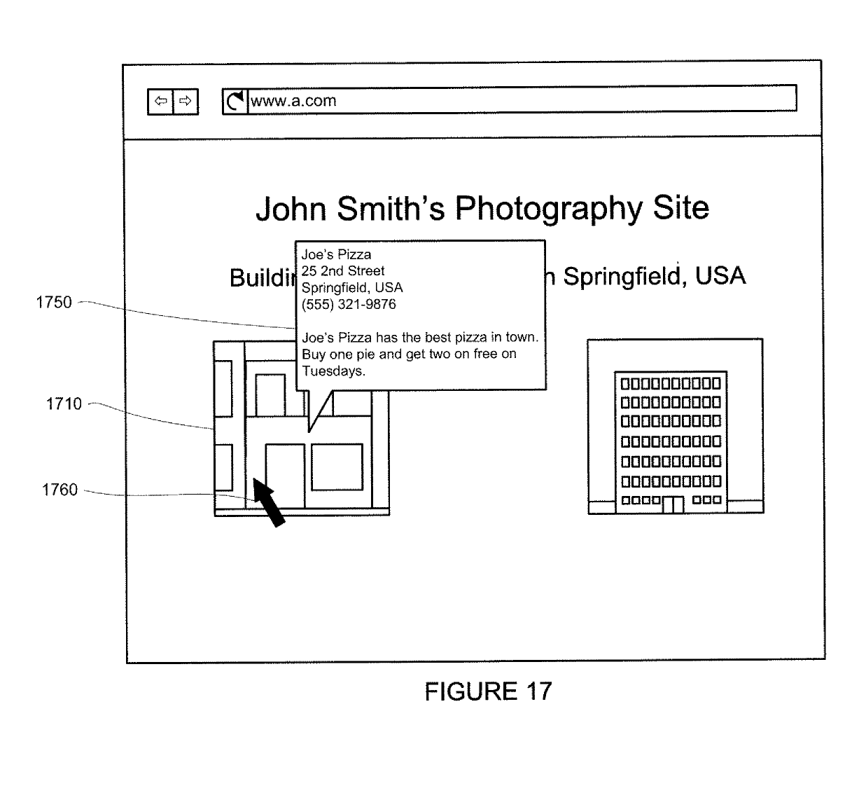

FIG. 17 illustrates an alternative aspect, wherein the advertisement 1750 is shown when the user hovers the mouse cursor 1760 over the matching image 1710.

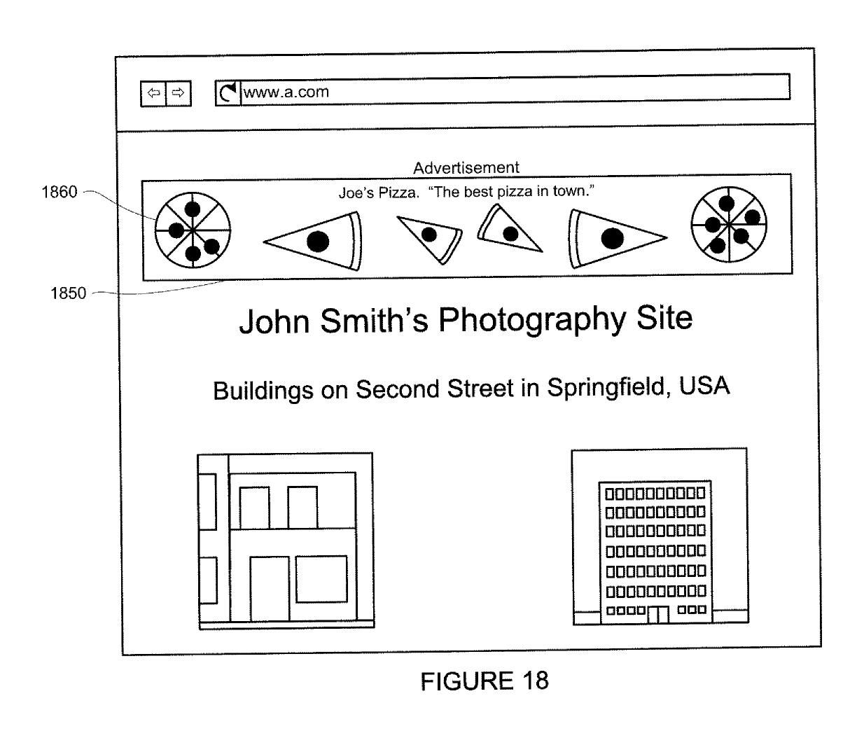

As shown in FIG. 18, the advertisement 1850 may also include non-text images 1860 in addition to text-based advertising.

In one aspect of the system and method, the advertisement associated with an image is displayed in connection with many different applications and platforms. For example, the same advertisement added to a Google Maps Street View image may be displayed in connection with visually-similar images that are shown by stand-alone applications such as Google Earth, by operating systems on mobile phones such as Google Android, and in various other devices such as in-car products and the like.

Moreover, multiple advertisements may be simultaneously displayed on the same display. By way of example only, if a webpage contains multiple images, an advertisement may be shown for each image. In addition, each advertisement may have been uploaded by a different user at a different node of the network.

In one aspect of the system and method, the user who placed the advertisement in connection with the first image pays the operators of the server that supplied the advertisement, the operator of the website that displayed the advertisement, or both.

The system and method is not limited to advertisements. By way of example only, if a listing 260 is associated with a street level image, the information in the listing may be displayed in lieu of an advertisement when a matching image is displayed.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “including” and the like) should not be interpreted as limiting the invention to the specific examples; rather, the examples are intended to illustrate only one of many possible embodiments.

1. A computer-implemented method of displaying content comprising:
receiving, by one or more computing devices, a user input associated with a selection of a pixel location within a first street level image, the first street level image depicting a geographic object and being associated with a first geographic location;
receiving, by the one or more computing devices, another user input including first content to be associated with the selected pixel location within the first street level image, the first content corresponding to adverting content associated with the geographic object depicted in the first street level image;
receiving, by the one or more computing devices, second information to be displayed, the second information being associated with a second image, the second image being associated with a second geographic location;
selecting, by the one or more computing devices, the first street level image based on the proximity of the first geographic location to the second geographic location, wherein the proximity of the first geographic location to the second geographic location is based on a latitude and longitude value of the first geographic location relative to the second geographic location;
determining, by the one or more computing devices, whether the first street level image and the second image depict a same geographic object; and
providing, by the one or more computing devices, the first content in response to receiving the second information when the first street level image and the second image are determined to depict the same geographic object, the first content being provided for display on an electronic display with the second information.

2. (canceled)

3. The method of claim 1 wherein determining whether the first street level image and the second image depict the same geographic object comprises comparing, by the one or more computing devices, a portion of the first street level image that is adjacent to the pixel location with the second image.

4. The method of claim 1 wherein the second information to be displayed is to be displayed on a web page.

5. (canceled)

6. The method of claim 1 wherein the first content and second information are included in the same web page to be displayed.

7. A computer-implemented method of displaying an advertisement comprising:
receiving, by one or more computing devices, an input associated with a selection of a pixel location within a first image, the first image being captured at a camera location;
receiving, by the one or more computing devices, advertising content to be associated with the first image at the selected pixel location;
receiving, by the one or more computing devices, a request for an advertisement, the request identifying a second image captured by a camera and identifying a second location;
selecting, by the one or more computing devices, the first image from among a plurality of images based on a comparison of a latitude and longitude value of the camera location with the second location, and a comparison of the visual appearance of the first image with the second image;
selecting, by the one or more computing devices, the advertising content based on the selection of the first image; and
transmitting, by the one or more computing devices, the advertising content for display with the second image.

8. The method of claim 7 wherein the second image and the advertisement are displayed on a web page.

9. The method of claim 8 wherein the second image is received from a server hosting a photography website.

10. (canceled)

11. The method of claim 7 wherein the first image is a street level image.

12. (canceled)

13. (canceled)

14. (canceled)

15. (canceled)

16. (canceled)

17. (canceled)

18. (canceled)

19. (canceled)

20. (canceled)

21. The method of claim 1, further comprising providing for display, by the one or more computing devices, the advertising content within the first street level image at the selected pixel location.

22. The method of claim 1, wherein determining whether the first street level image and the second image depict the same geographic object comprises identifying matching features contained within both the first street level image and the second image.

23. The method of claim 22, further comprising comparing a number of matched features identified for the first street level image and the second image to a threshold in order to determine whether the first street level image and the second image depict the same geographic object.

24. The method of claim 1, wherein the first content is only provided for display with the second information when an input cursor is positioned over the second image.

25. The method of claim 7, further comprising providing for display, by the one or more computing devices, the advertising content within the first image at the selected pixel location.

26. The method of claim 7, wherein selecting the first image from among a plurality of images based on a comparison of a latitude and longitude value of the camera location with the second location, and a comparison of the visual appearance of the first image with the second image comprises determining whether the first image and the second image depict a same geographic object by comparing a portion of the first image that is adjacent to the pixel location with the second image.

27. The method of claim 7, wherein the first content is only provided for display with the second information when an input cursor is positioned over the second image.

28. A system for displaying content, comprising:
one or more computing devices including one or more processors and associated memory, the memory storing instructions that, when implemented by the one or more processors, configure the one or more computing devices to:
receive a user input associated with a selection of a pixel location within a first street level image, the first street level image depicting a geographic object and being associated with a first geographic location;
receive another user input including first content to be associated with the selected pixel location within the first street level image, the first content corresponding to advertising content associated with the geographic object depicted in the first street level image;
receive second information to be displayed, the second information being associated with a second image, the second image being associated with a second geographic location;
select the first street level image based on the proximity of the first geographic location to the second geographic location, wherein the proximity of the first geographic location to the second geographic location is based on a latitude and longitude value of the first geographic location relative to the second geographic location;
determine whether the first street level image and the second image depict a same geographic object; and
provide the first content in response to receiving the second information when the first street level image and the second image are determined to depict the same geographic object, the first content being provided for display on an electronic display with the second information.

29. The system of claim 28, wherein the one or more computing devices are configured to determine whether the first street level image and the second image depict the same geographic object by comparing a portion of the first street level image that is adjacent to the pixel location with the second image.

30. The system of claim 28, wherein the one or more computing devices are configured to provide the advertising content for display within the first street level image at the selected pixel location.

31. The system of claim 28, wherein the one or more computing devices are configured to determine whether the first street level image and the second image depict the same geographic object by identifying matching features contained within both the first street level image and the second image.

32. The system of claim 28, wherein the one or more computing devices are configured to display the first content within the second information only when an input cursor is positioned over the second image.
